(19) United States
(12) Patent Application Publication
(10) Pub. No.: US 2007/0115098 A1
(43) Pub. Date: May 24, 2007

(54) RFID SYSTEM INCLUDING TAGS HAVING LOW RF SCATTERING MODE

(75) Inventor: Daniel Mark Dobkin, Sunnyvale, CA (US)

Correspondence Address: BEYER WEAVER LLP, P.O. BOX 70250, OAKLAND, CA, 94612-0250, US

(73) Assignee: WJ COMMUNICATIONS, INC., San Jose, CA (US)

(21) Appl. No.: 11/427,991

(22) Filed: Jun. 30, 2006

Related U.S. Application Data
(60) Provisional application No. 60/737,958, filed on Nov. 18, 2005.

(51) Int. Cl. H04Q 5/22

(52) U.S. Cl. 340/10.2; 340/572.7; 340/10.31

(57) ABSTRACT

A radio frequency identification (RFID) system includes a plurality of RFID tags addressable by a tag reader, with each tag comprising a RF antenna, an integrated circuit including a memory for identification data and coupled to the antenna, the integrated circuit being configured to have a first antenna load impedance when accessed by the tag reader and a second higher load impedance after access by tag reader whereby the tag switches to a low scattering state for a finite period of time to reduce scattering of signals from the tag reader.

### CROSS REFERENCE TO RELATED APPLICATION

This application claims the benefit of priority under 35 USC 119(e) to U.S. Provisional Application No. 60/737,958, filed Nov. 18, 2005, entitled “Multiple-Tag RFID Using Low-Scattering Tag Mode”, which is incorporated herein by reference in its entirety for all purposes.

### BACKGROUND OF THE INVENTION

This invention relates generally to radio frequency identification (RFID) systems in which a plurality of RFID tags can be sequentially accessed for identification information, and more particularly the invention relates to a system in which each RFID tag can switch to a low RF signal scattering mode to reduce interference when another RFID tag is being addressed.

Radio frequency identification (RFID) is a method of identification in which a RFID tag or transponder comprising an antenna and a integrated circuit including a memory for the identification data can be addressed by a RFID reader. The RFID systems are in use today for various applications including inventory control and automobile toll collection.

The RFID tags can be passive with no internal power supply in which RF power from a reader is received by the tag antenna and sufficient power is transferred to the integrated circuit to permit code recognition and transmission of the stored identification data to the reader.

It may be of interest to be able to read UHF RFID tags in situations where many tags are present in the read zone of a reader, either as a regular array (e.g. when marking stacked boxes or items of identical size) or as a random array. In this case the scattering of the signal by the tag antennas can represent a significant obstacle. As the signal from the reader propagates it is scattered by the tag antennas, causing a reduced signal for tags that are ‘shadowed’ by many layers of preceding tags. A regular array should have some preferred scattering directions along which the signal is actually increased relative to that when no tags are present. The fact that the first tags to be read are sent to an inactive or ‘QUIET’ state after being read does not necessarily help. The default or inactive state of a tag antenna is usually chosen to absorb energy from an impinging field in order to provide power to the integrated circuit that operates the tag, and by elementary antenna theory the best that can be done is to scatter at least as much power as is absorbed by the antenna.

### SUMMARY OF THE INVENTION

In accordance with the invention, a radio frequency identification system includes a plurality of RFID tags addressable by a tag reader which are sequentially accessed by addressing a first RFID tag using a first command from a tag reader, reading information from the first RFID tag, instructing the first RFID tag to switch to a low RF signal scattering state (“INVISIBLE” state) and then addressing a second RFID tag using a second command from the tag reader. By reducing the scattering of RF signal by tags which have already been addressed, more signal is available for tags not yet accessed and which might be partially shadowed or covered by layers of preceding tags.

Each RFID tag comprises a RF antenna and integrated circuit including a memory for the identification data which is coupled to the antenna. The integrated circuit can be configured to have a first antenna load impedance when accessed by the tag reader, and a second, high load impedance after access by the tag reader which effectively reduces power scattered by the tag antenna. After data is received by the reader from an addressed tag, a singulated command is transmitted to the tag and instructs the tag to go to the low-scattering invisible state. The low-scattering state can be effected by changing the capacitance of the integrated circuit load presented to the antenna, or by disconnecting the integrated circuit from the antenna, for example. Field effect transistor switches can be used to effect these circuit changes. The low-scattering or “INVISIBLE” state assumed by the tag will typically last for a limited period of time, determined in part by charge leakage in the FET switch, but the time period can be sufficient for the accessing of all tags by the tag reader.

The invention and objects and features thereof will be more readily apparent from the following detailed description and appended claims when taken with the drawings.

### BRIEF DESCRIPTION OF THE DRAWINGS

FIG. 1 is a block diagram of an experimental configuration using front plane and back plane of tags, with an inset showing examples of I-tags and squiggle tag types.

FIG. 2 is a chart illustrating the number of tags read in the front and back planes as a function of the distance between the planes, where the tags are I-tags.

FIG. 3 is a chart illustrating the number of tags read in the front and back planes as a function of the distance between the planes, where the tags are ‘squiggle’ tags.

FIG. 4 is a schematic diagram of an equivalent circuit for an exemplary tag antenna.

FIG. 5 is a Smith chart depicting a reflection coefficient for the equivalent circuit of FIG. 4, seen from Port 1 of the exemplary tag antenna, as a function of frequency.

FIG. 6 is a chart illustrating variations of a voltage across a radiation resistance and a voltage across an integrated circuit (IC) in the exemplary tag antenna as a function of a load capacitance.

FIG. 7 is a chart illustrating a radar cross-section as a function of frequency for test structures comparable to the geometry modeled in FIGS. 4-6, with varying load capacitance.

FIG. 8 is a chart illustrating the radar cross-section as a function of load capacitance for the test structures of FIG. 7, with frequency fixed at 905 MHz.

FIG. 9 is a block diagram of an experimental configuration for a feasibility test of ‘invisible’ tag antennas.

FIG. 10 is a schematic depiction of tags in a dense array in front of a reader antenna, with tags successfully read in any of a number of inventory attempts shown as dark blocks and tags present but not successfully read shown as white blocks.

FIG. 11 is a schematic depiction of tags read in the dense array when two rows in the dense array nearest to the reader antenna are replaced with test structures using a 1.8 pF load, which are labeled as ‘1.8 pF’.

FIG. 12 is a schematic depiction of tags read in the dense array when two rows in the dense array nearest to the reader antenna are replaced with test structures using a 1.1 pF load, labeled ‘1.1 pF’.

FIGS. 13A, 13B are schematic diagrams of an equivalent circuit of a tag antenna in accordance with one embodiment of the invention.

FIG. 14 is a plot of voltage across resistor R1 in FIG. 4 as a function of frequency (MH₃).

FIG. 15 is a plot of load conductance at port 1 in FIG. 4 versus voltage across resistor R1.

### DETAILED DESCRIPTION

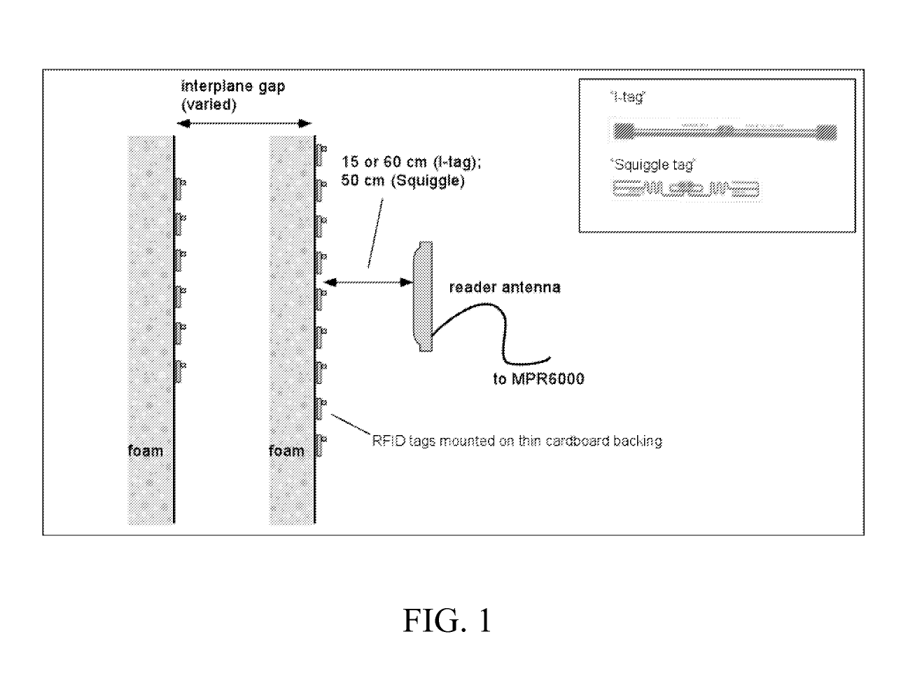

I have carried out measurements in the configuration depicted in FIG. 1, in which two planes of commercial UHF RFID tags (model 9350 ‘I-tags’, manufactured by Alien Technology) mounted on thin slices of cardboard and the latter supported by non-conductive foam boards, are placed in the normal range of an RFID reader, and the spacing between the planes varied. The planes are oriented so that their normal vector points towards the reader antenna. The plane nearest the reader, i.e., the first or front plane, includes 27 tags organized in three vertical columns of nine tags each, spaced 5 cm apart vertically and 20 cm apart horizontally. The second or back plane includes 18 tags, in 3 columns of 6 tags each, spaced in the same fashion. This configuration emulates what would be encountered in trying to read two layers of cartons or boxes, each of which is identified using an RFID tag.

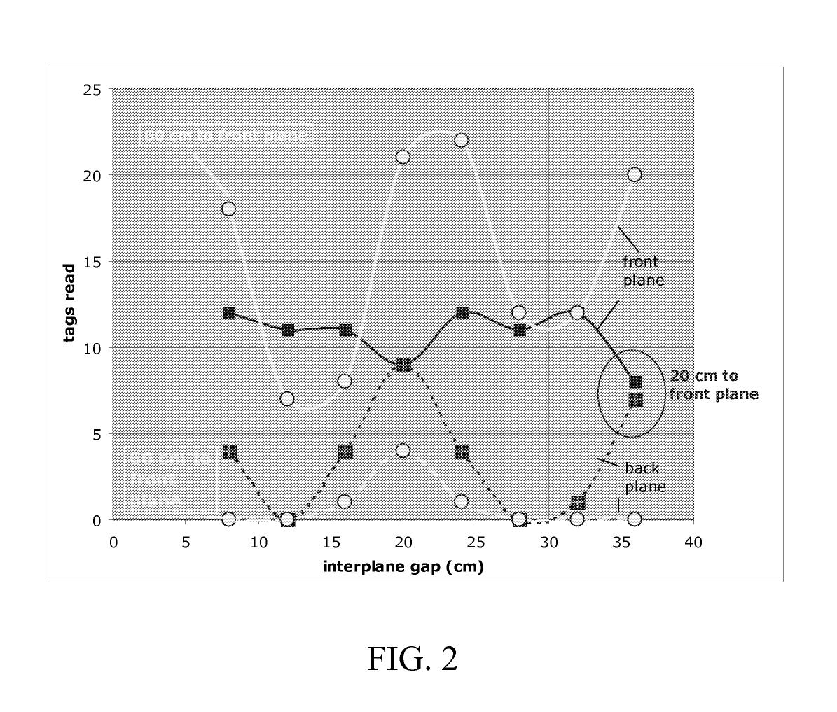

FIG. 2 shows the resulting ability of a commercial RFID reader (WJ Communications MPR6000), placed at different distances, for example, 20 cm and 60 cm, from the front plane, to read tags in the first and second planes, using a 9 dBi antenna and 27 dBm output power, and implementing the EPCglobal class 1 anti-collision algorithm. It is apparent that the front plane is read with good effectiveness, though varying with the spacing between the planes, but the back plane is seen very poorly by the reader except for certain very specific spacings between the planes. (The larger number of tags read in the front plane at 60 cm spacing to the reader antenna is primarily the result of the antenna pattern, which allows more tags to be illuminated at longer spacing.) The periodicity of the results, showing good read effectiveness for the front plane at roughly 16 cm intervals of inter-plane gap, when the antenna spacing is 60 cm, is about ½ of a wavelength at 925 MHz, the approximate frequency at which the experiments are carried out, suggesting that scattering between the planes may be dominating the results.

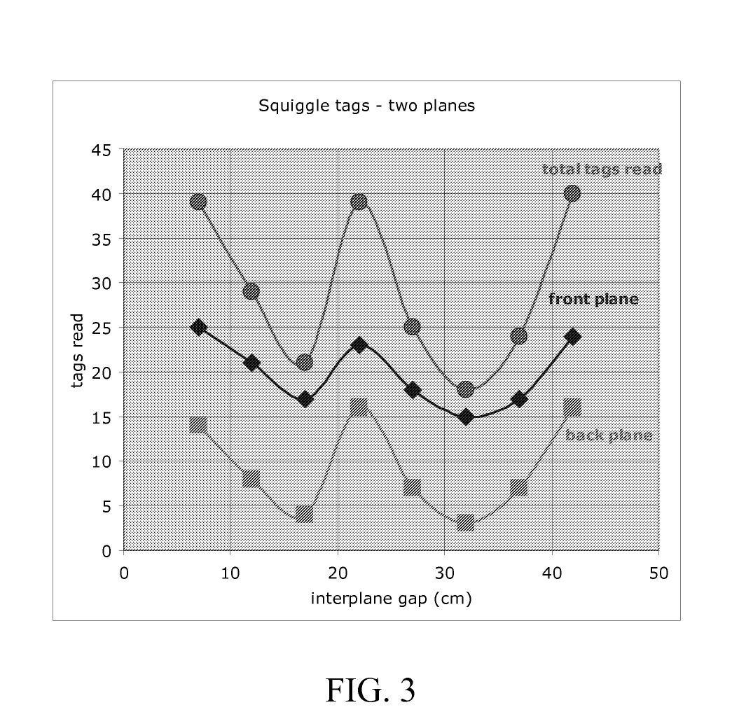

FIG. 3 shows the results of experiments using the same configuration, but replacing the ‘I-tags’ with model 9238 ‘Squiggle tags’. Squiggle tags are produced by the same manufacturer as I-tags, but use a partially-meandered dipole design to provide a smaller tag width. I have verified that as a consequence, the radar scattering cross-section of a Squiggle tag is much lower than that of an I-tag; some relevant data is summarized in Table 1. I have also observed that Squiggle tags generally display shorter read ranges than I-tags seen in FIG. 3 is a much improved ability to read the back plane of tags, and a very pronounced periodicity of roughly 16 cm in both front and back tag reads.

TABLE 1
Radar scattering cross-section for different RFID tags

| | Radar cross-section at 910 MHz |
|---|---|
| Tag type | (cm²) |
| I-tag | 150-270 |
| Squiggle | 30 |

TABLE 2
Percentage of tags read for different tags and configurations

| | | Tags read (% of tags present) | | |
|---|---|---|---|---|
| Tag type | Configuration | Front plane | Back plane | All |
| I-tag | 60 cm antenna-tags; 20 cm | 78 | 22 | 56 |
| | interplane gap | | | |
| | 60 cm antenna-tags; 28 cm | 44 | 0 | 27 |
| | interplane gap | | | |
| Squiggle | 50 cm antenna-tags; 22 cm | 85 | 89 | 87 |
| tag | interplane gap | | | |
| | 50 cm antenna-tags; 32 cm | 56 | 17 | 40 |
| | interplane gap | | | |

Table 2 summarizes the results for reading tags. It is apparent that, even though the read range for an isolated Squiggle tag is less than that of an I-tag, when a large number of closely spaced tags are present, the Squiggle tags give superior performance due to their reduced scattering cross-section. It is also apparent that scattering remains a major problem even for the Squiggle tags, with the ability to read tags very dependent on the spacing between planes of tags. Such dependence on spacing is undesirable in practice, as it implies that the ability to read the tags in commercially-important configurations such as stacks of tagged boxes or cartons will be affected by the size of cartons, density of packing, orientation, tag placement on each box, and other variables. Such sensitivity makes it very difficult to employ UHF RFID for inventory and tracking of closely-spaced tagged items. Therefore it would be desirable to reduce the effects of tag scattering without impacting the read range of the tags.

The present invention provides a tag protocol with a command instructing the tag to go to a special ‘low-scattering’ state. In one embodiment, this command is given after each particular tag is read using a ‘singulated’ command addressed only to that tag (at the cost of a reduction in the speed with which the group of tags are read).

The present invention also provides a tag equipped with the ability to switch to a low-scattering state for a finite period of time comparable to a likely duration of an inventory operation (e.g., some hundreds of milliseconds). In one embodiment, current flowing in at least one portion of the tag antenna that radiates effectively is minimized in the low-scattering state. In one example, where the tag antenna is configured as a simple dipole with an integrated circuit (IC) of the tag in the middle, the low-scattering state would be that in which the IC presents a very large resistance and negligible capacitance to the dipole, resulting in an open-circuit load. In other examples cases, a matching structure is present in the tag antenna. Many antennas use what amounts to a shunt inductor around the dipole. In this case, the low-scattering state would use a capacitance appropriate to create a parallel resonance with the shunt inductor, and a very large resistance, to present a very large load in effect to the remainder of the antenna at the frequencies of interest. For other matching structures, the low-scattering load is selected similarly to minimize the current flow in the (generally longer) part of the antenna. These states can be imposed using conventional FET-based switches connected to appropriate elements on-chip. Even further reductions in scattering can be obtained by interposing additional switches along the length of the antenna wiring, to separate the antenna into electrically isolated short segments, with very low scattering, but such provisions will add considerable cost and complexity to the tags and are unlikely to be suitable for general-purpose applications.

In one embodiment of the present invention, an array of tags are read by a reader, and as each tag is read it is instructed to go to the low-scattering state. The first tags to be read may be the one nearest the reader, or in locations where ambient scattering or the combination of tag and ambient scattering fortuitously provides increased signal strength. As these tags are turned to the low-scattering or “INVISIBLE” state, on average the penetration of the reader signal will increase, allowing tags buried more deeply in the array to be accessed by the reader.

### EXAMPLE 1

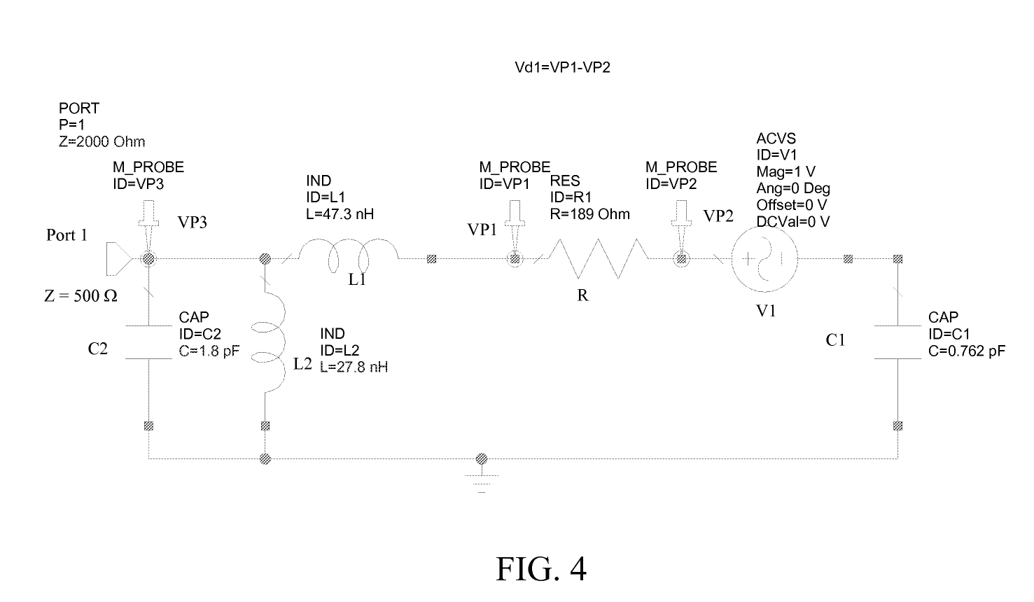

A simplified approximate equivalent circuit for a representative tag antenna structure similar to that used in the Alien model 9350 tags is shown in FIG. 4, where parameters have been chosen for maximum power transfer to the integrated circuit. In the QUIET state, the tag receives power but does not modulate its impedance to transmit a backscattered signal.

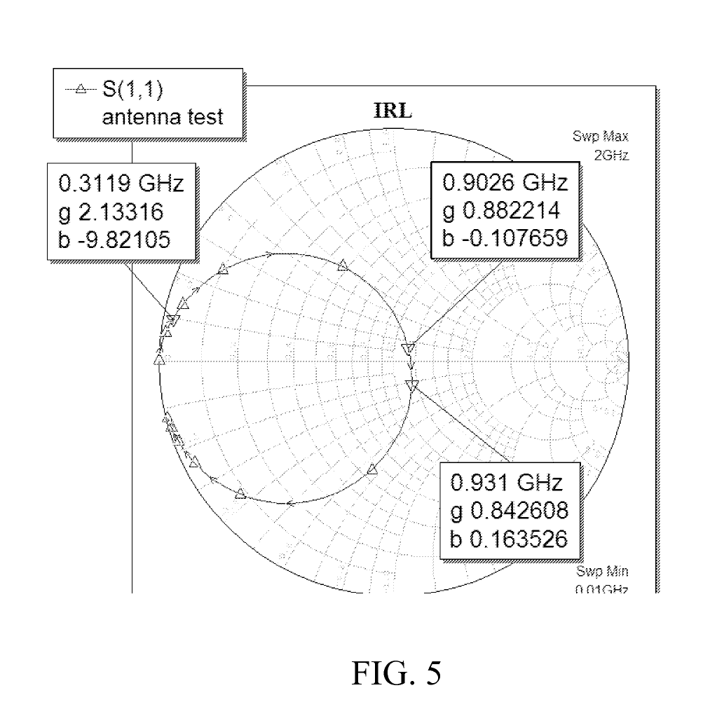

In FIG. 4, port 1 is located at a connecting point to the antenna, which is the electrical location where the tag integrated circuit would normally be connected to the antenna. The inductor L2 represents the equivalent inductance of a shunt tuning structure (FIG. 5) and is mainly non-radiating. An incident wave is represented by the voltage source V1. The antenna reflection coefficient looking outwards from Port 1 is shown in FIG. 5. Capacitor C2 represents the IC load capacitance with any associated parasitics. Port 1 is adjusted to 500 ohms to represent the load resistance of an exemplary integrated circuit. The antenna is constructed to deliver maximum power and voltage to the fixed load resistance of the integrated circuit.

FIG. 5 shows the reflection coefficient of the antenna and IC capacitance as viewed from port 1 (equivalent to the IC load). The antenna provides a good match to the IC load of around 500 ohms at about 900-930 MHz, appropriate for use in the US Industrial Scientific and Medical band from 902-928 MHz. Under these conditions, the voltage across the resistor R1 when the voltage source V1 (representing an incident electric field) is set to 1 V, is about 0.48 V. This represents scattered power from the antenna in the QUIET state. When the protocol instructs the tag to become quiet, it no longer modulates its backscattered signal, but the scattered power remains substantial.

In the new “INVISIBLE” state, the tag scattering is reduced to a minimum value. In order to reduce the power scattered by the tag antenna, the voltage across R1 is reduced by reducing the current in the antenna. This can be accomplished by simultaneously increasing the resistance of the load using a FET switch, and changing the load capacitance.

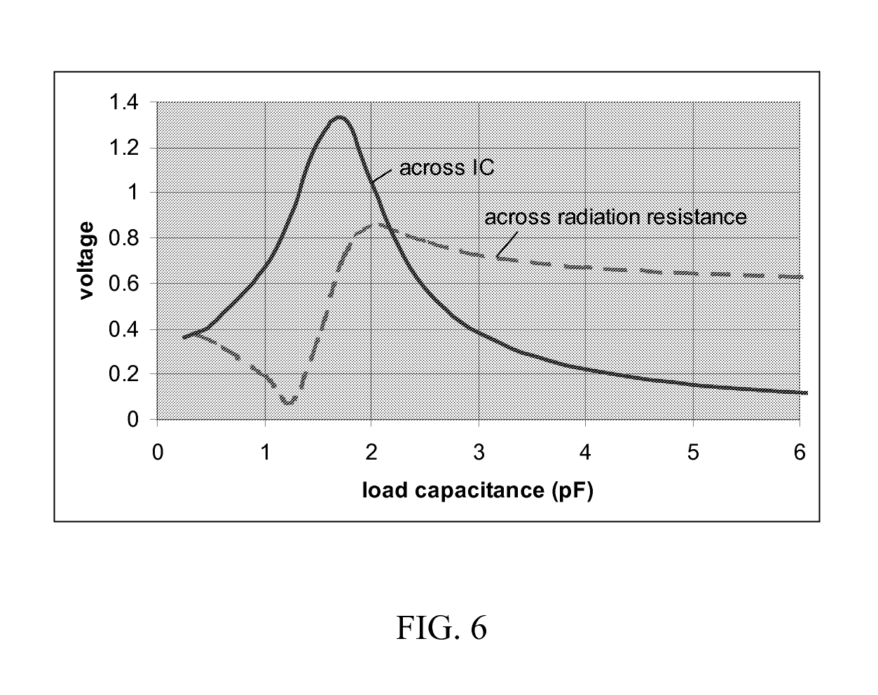

FIG. 6 shows the effect of load capacitance C2 on the voltage across the radiation resistance R1 as well as the voltage on the port P1 representing the IC, with the port impedance increased to 2000 ohms (representing an open switch with some parasitic dissipation), and frequency fixed at 910 MHz. The power dissipated in the radiation resistor R1 is minimized when the capacitance is adjusted to about 1.2 pF. In this condition the voltage on R1 is reduced to about 0.08 V. The power dissipation in R1, which represents power scattered from the antenna, is decreased by a factor of (0.08/0.48)2=0.03. That is to say, with the appropriate load adjustment, the scattered power from the antenna in the INVISIBLE state is reduced to about 3% of that encountered in the QUIET state. It is clear that tags in the INVISIBLE state should provide much less impediment to the propagation of signals from the reader, and allow other tags not yet read to be accessed by the reader.

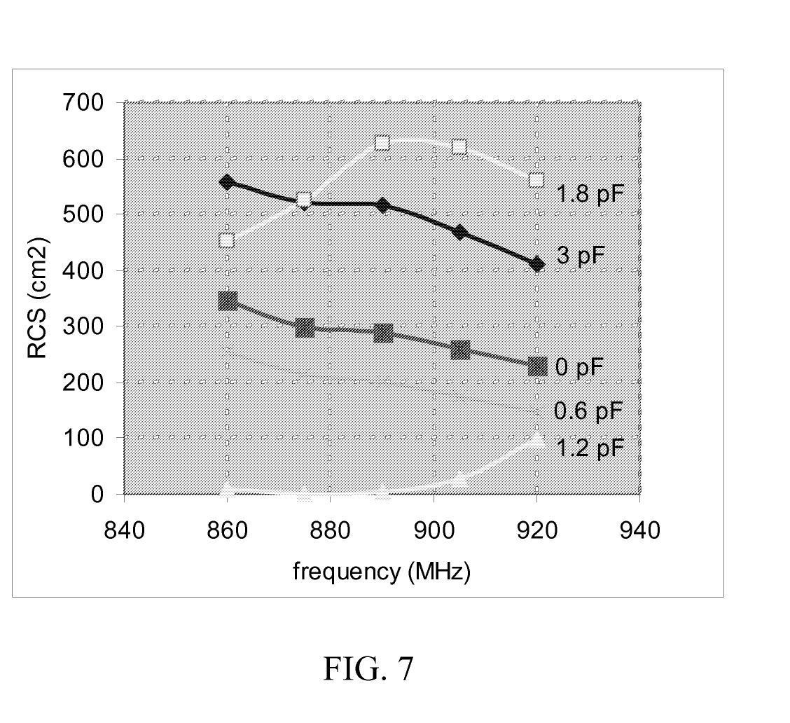

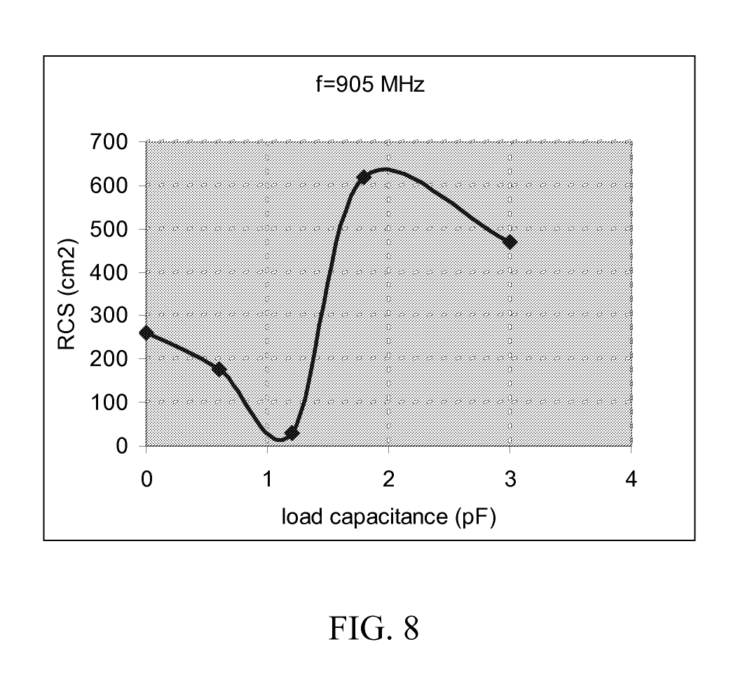

Actual measured radar cross-section data on antenna structures fabricated on an FR4 printed circuit board are shown in FIGS. 7 and 8, as a function of frequency and load capacitance. There appears to be excellent agreement between the dashed line in FIG. 6 and the data of FIG. 8.

### EXAMPLE 2

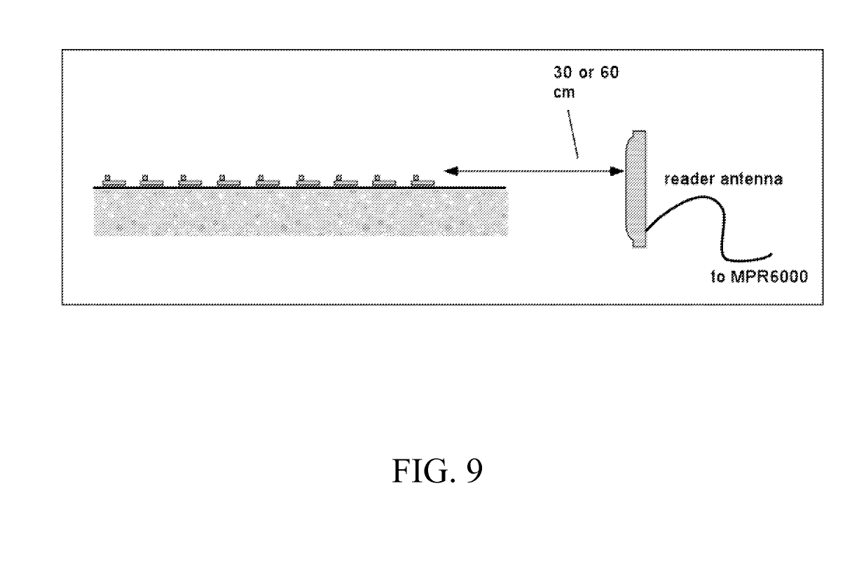

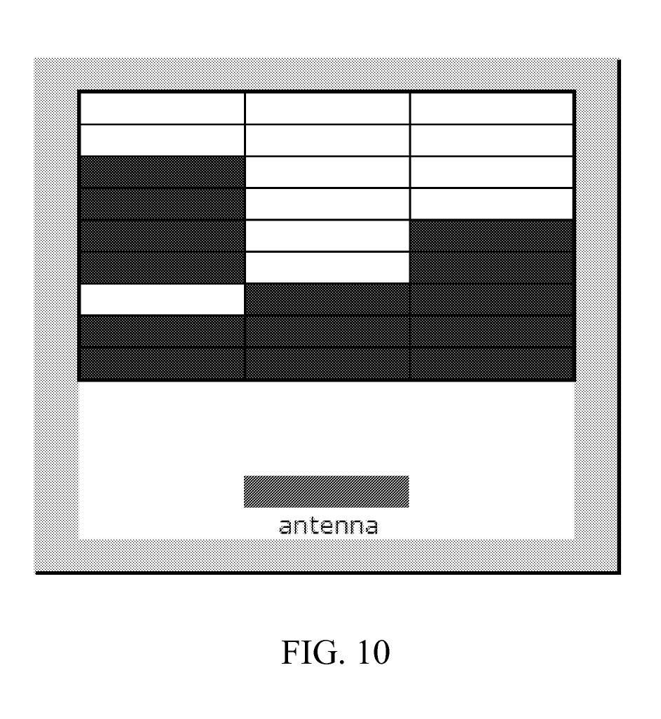

Three columns of nine model 9350 I-tags with antenna test structures described in Example 1 were mounted on thin cardboard backing and placed on a non-conductive foam support, oriented so that the propagation vector of the reader signal is aligned in the plane of the support, as shown in FIG. 9. A commercial RFID reader (WJ MPR7000) with a 6 dBi horizontally polarized antenna is used in an attempt to read the tags, using 1 Watt RF power and the EPCglobal class 1 anti-collision algorithm, within the US ISM band of 902-928 MHz. From 90 to 130 ‘inventory attempts’ were used, over the course of several seconds, for each experiment. Each inventory attempt involves execution of the required anti-collision algorithm (often known as the ‘PING’ algorithm after the name of the relevant command) until a certain number of failed read attempts have been accumulated. A frequency hop is executed between each inventory attempt, in a pseudo-random fashion from one channel to another within the ISM band. As shown in FIG. 10, only the tags nearest the reader antenna could be read, even though the most distant tags are well within range of the reader if isolated.

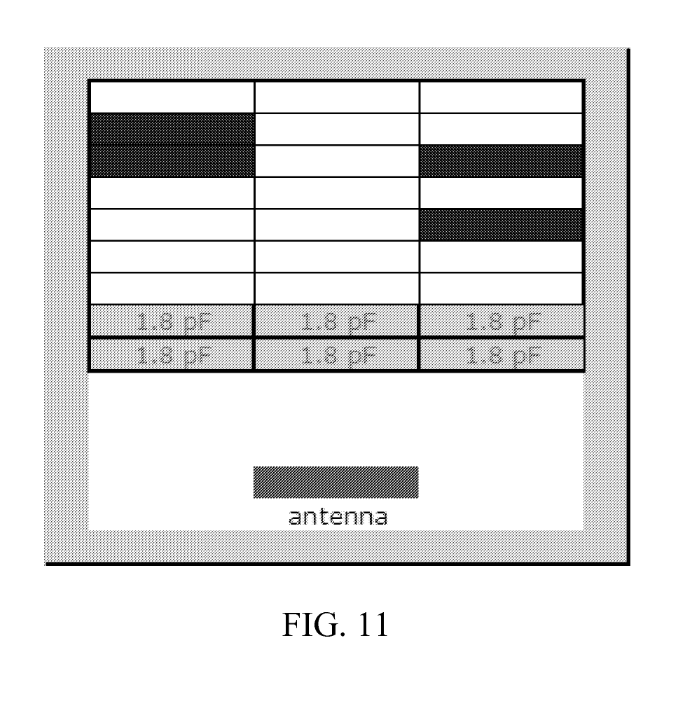

In the second experiment, the two rows of I-tags nearest the reader were replaced by antenna test structures with a load capacitance of 1.8 pF, expected to scatter strongly based on the results shown in FIG. 7. The results are summarized in FIG. 11. Only 4 tags can be read in this case, relatively distant from the strong scattering test structures.

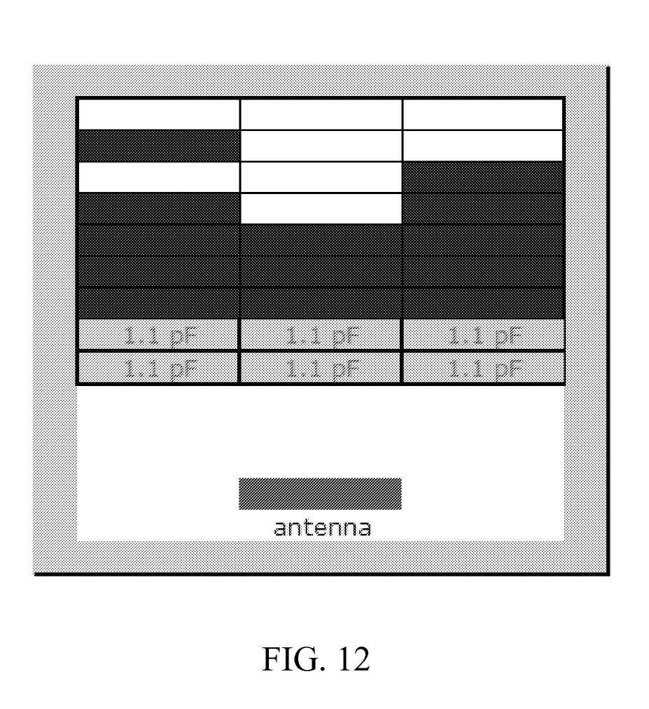

In the third experiment, the first two rows were populated with identical antenna test structures save for the use of a 1.1 pF load capacitance; from the results of FIG. 7, such tags are expected to scatter very little energy. By comparison with FIG. 10, it is apparent that the region in which tags are ‘visible’ to the reader has been displaced deeper into the array of tags relative to its location in the initial configuration, corresponding to the minimization of scattering from the two rows of the array nearest the reader. If the reader were to attempt to read tags in the original configuration as in FIG. 10, and then cause the first two rows of tags read to become INVISIBLE, producing the results shown in FIG. 12, then 20 of the 27 tags present would be successfully read, instead of only 14 as when all tags are at best QUIET. I have verified that when 3 or 4 rows are replaced with ‘invisible’ tags, all or nearly all the remaining tags are read by the reader. It is clear that by causing tags to become INVISIBLE rather than merely QUIET, a considerable improvement in ability to read tags in a dense array is achieved.

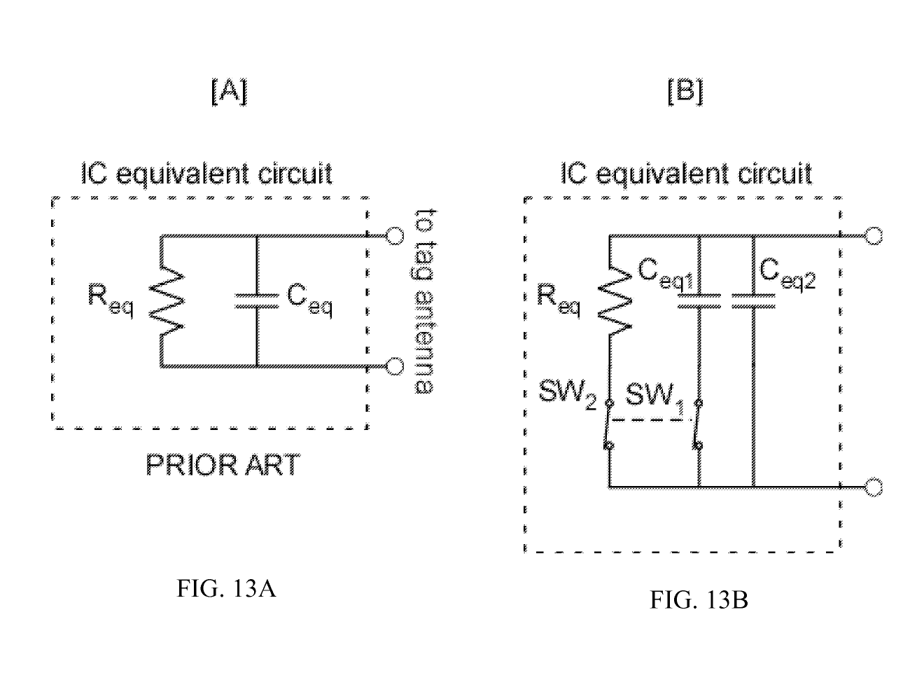

In practice, the change in load impedance can be implemented by designing a portion of the tag equivalent input capacitance to be switchable, in the case where it is desirable to match to a larger capacitance than the capacitance in which the minimum scattering state is obtained. Since the tag input capacitance is typically primarily due to input diodes placed in parallel (for the RF signal) to act as a charge pump providing power to the IC, such an approach involves making a portion of the input charge pump switchable. With this approach only an additional switch is required, and all the input capacitance is due to potentially useful diode structures. No chip space need be employed for capacitance which is not used in the normal operating state of the chip. An exemplary implementation is shown schematically in FIG. 13B. SW1 is a normally-closed switch that can be implemented as a conventional depletion-mode FET switch; the input charge pump diodes are partitioned into two sections whose equivalent input capacitances are Ceq1 and Ceq2. In normal tag operation or the QUIET state, this switch is closed and the load capacitance is the sum Ceq=Ceq1+Ceq2. In the INVISIBLE state, the switch is opened, reducing the input capacitance to Ceq2. Alternatively, both switch SW1 and SW2 can be opened which disconnects the IC from the antenna in the INVISIBLE state.

The INVISIBLE state can be maintained as long as the tag IC has sufficient power to keep the relevant switches open or closed. The switches supporting the INVISIBLE state may be charged through normally-off devices which are then allowed to revert to their default OFF state. In this fashion the tag will remain INVISIBLE even if power to the logic portion of the IC is lost. The persistence time in the INVISIBLE state would be limited by the ratio of the charge stored in the relevant switches to the gate leakage of those switches. The exact time is implementation-dependent, but persistence times long compared to inventory times (typically 50-100 msec depending on the protocol) can be achieved with conventional CMOS technology.

A command to implement the INVISIBLE state can be included in existing tag protocols, and tags and readers implementing the INVISIBLE state can remain backward-compatible with conventional tags and readers. For example, in the EPCglobal Class 1 Generation 2 tag protocol, the command codes 1110 0000 0000 0000 through 1110 0000 1111 1111, and 1110 0001 0000 0000 through 1110 0001 1111 1111 are reserved for custom and proprietary commands, respectively. Such commands may be defined by a manufacturer and implemented by a tag which is in other respects completely compatible with the EPCglobal Generation 2 tag protocol, and tags implementing custom or proprietary commands remain compliant with the requirements of the standard as long as those commands do not replicate mandatory or optional commands within the standard. Thus a specific proprietary or custom command can be readily defined to cause a tag to become INVISIBLE. Naturally, it is also possible for protocols to be defined explicitly including the INVISIBLE state of a tag.

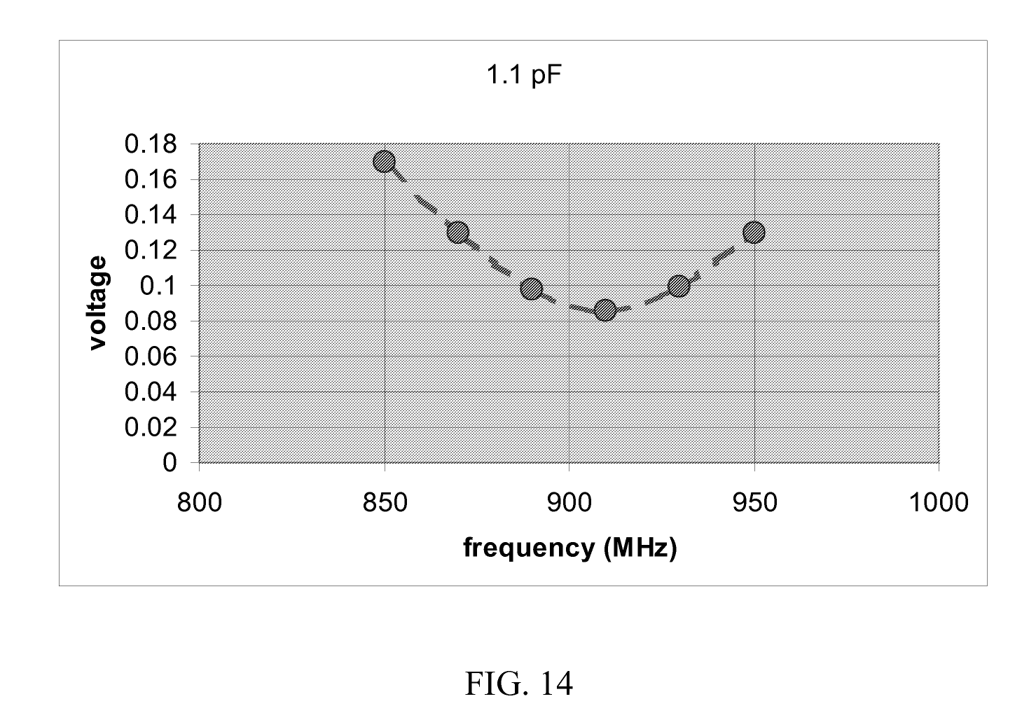

FIG. 14 shows the simulated voltage across the radiation resistor R1 (for a slightly different capacitance value of 1.1 pF) as a function of frequency, demonstrating that low scattering is maintained readily over the US Industrial, Scientific, and Medical band from 902-928 MHz, and indeed reasonable performance is obtained over the whole 850-950 MHz band in which UHF RFID is envisioned to operate.

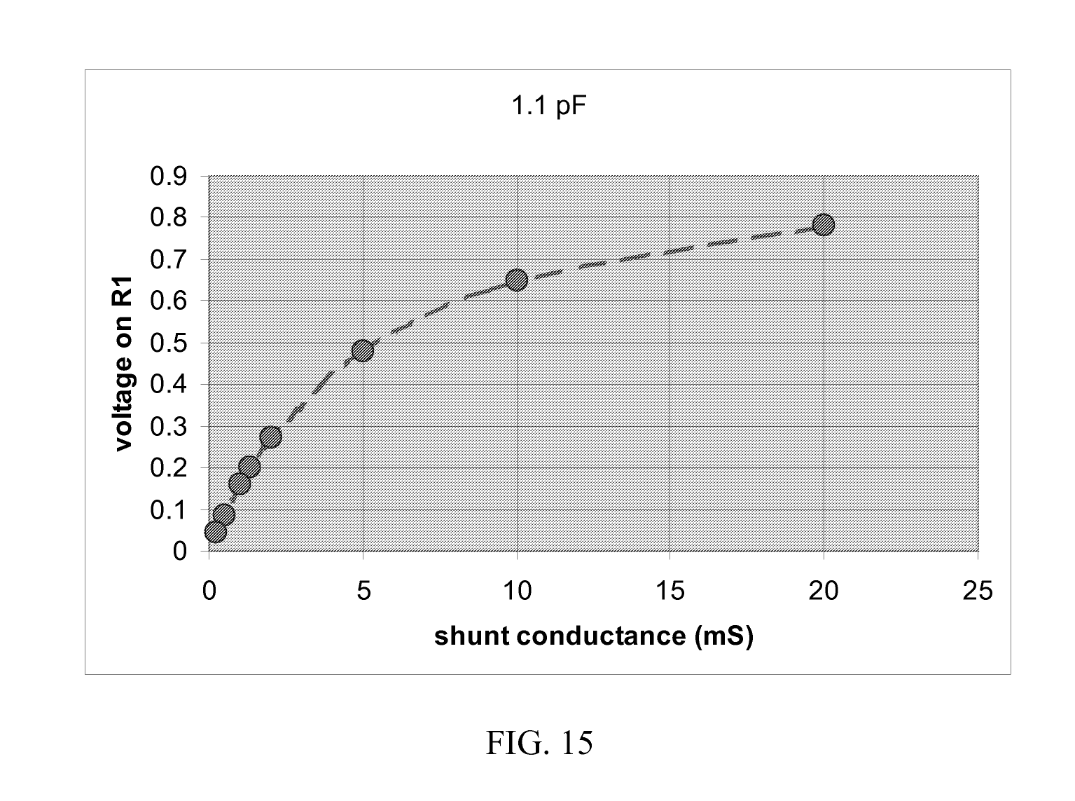

FIG. 15 shows the simulated voltage as a function of the load conductance (the inverse of the impedance Z of port 1 of FIG. 4). It is apparent that, while the best results are obtained at zero conductance, conductances of up to 1-2 mS (equivalent to shunt resistance of 500-1000 ohms) can be tolerated with minimal increases in the scattered power.

While the invention has been described with reference to specific embodiments, the description is illustrative of the invention and is not to be construed as limiting the invention. Various modifications and applications may occur to those skilled in the art without departing from the spirit and scope of the invention as defined by the appended claims.

What is claimed is:

1. In a radio frequency identification (RFID) system including a plurality of RFID tags addressable by a tag reader, each RFID tag having an antenna and an integrated circuit, a method of sequentially accessing RFID tags comprising the steps of:
a) addressing a first RFID tag using a first command from the tag reader,
b) reading information from the first RFID tag,
c) instructing the first RFID tag to switch to a low RF signal scattering state, and
d) addressing a second RFID tag using a second command from the tag reader.

2. The method of claim 1 wherein steps a)-d) are repeated until all RFID tags have been addressed.

3. The method of claim 2 wherein step c) uses a singulated command addressed to the RFID tag.

4. The method of claim 2 wherein in step c) the instructed RFID tag switches to the low RF signal scattering state for a period of time sufficient for the accessing of all RFID tags.

5. The method as defined by claim 4 wherein in step c) the instructed RFID tag switches to an increased antenna load impedance.

6. The method of claim 5 wherein in step c) the increased antenna load impedance results from reducing capacitance of the RFID tag.

7. The method of claim 5 wherein in step c) the increased antenna load impedance results from disconnecting the integrated circuit from the antenna.

8. The method of claim 1 wherein in step c) the instructed RFID tag switches to the low RF signal scattering state for a period of time sufficient for the accessing of all RFID tags.

9. The method of claim 8 wherein in step c) the instructed RFID tag switches to an increased antenna load impedance.

10. The method of claim 9 wherein in step c) the increased antenna load impedance results from reducing capacitance of the RFID tag.

11. The method of claim 9 wherein in step c) the increased antenna load impedance results from reducing capacitance of the RFID tag.

12. A radio frequency identification (RFID) tag having identification data accessible by a tag reader comprising a RF antenna, an integrated circuit including a memory for the identification data and coupled to the antenna, the integrated circuit being configured to have a first antenna load impedance when accessed by the tag reader and a second higher load impedance after access by the tag reader.

13. The RFID tag as defined by claim 12 wherein the second higher load impedance results from reducing capacitance of the integrated circuit as seen by the antenna.

14. The RFID tag as defined by claim 13 wherein the integrated circuit includes a shunt capacitance at the antenna port and a FET switch for disconnecting the shunt capacitance.

15. The RFID tag as defined by claim 14 wherein the integrated circuit includes an FET switch coupling the integrated circuit to an antenna port, the FET switch being responsive to a command from the tag reader.

16. The RFID tag as defined by claim 12 where the second higher load impendence results from decoupling the integrated circuit from the antenna.

17. The RFID tag as defined by claim 16 wherein the integrated circuit includes a FET switch coupling the integrated circuit to an antenna port, the FET switch being responsive to a command from the tag reader.
